(19) United States
(12) Patent Application Publication
(10) Pub. No.: US 2005/0015299 A1
(43) Pub. Date: Jan. 20, 2005

(54) Advertising system for providing a message at point of purchase location

(76) Inventor: Vahe Sisserian, Paris (FR)

Correspondence Address: Joseph W. Flerlage;Brinks Hofer Gilson & Lione, NBC Tower, Suite 3600, P.O. Box 10395, Chicago, IL, 60610, US

(21) Appl. No.: 10/621,089

(22) Filed: Jul. 15, 2003

(51) Int. Cl. G06F 17/60

(52) U.S. Cl. 705/14

(57) ABSTRACT

An advertising system provides an unexpected benefit to a customer of a merchant. The benefit may take the form of an immediate price reduction for a current transaction between the customer and the merchant and is provided to the customer based on the transaction with the merchant and without customer interaction. The customer is provided a notification that the benefit is a courtesy of an advertiser. The advertiser may be a third party merchant, manufacturer, service provider, or the like. The advertiser may compensate the vendor for the amount of the price reduction or a portion thereof.

### BACKGROUND OF THE INVENTION

1. Technical Field

The present invention relates generally to systems and methods for presenting a message. More particularly, the present invention relates to a system for presenting an advertising message and remuneration to a customer participating in a consumer transaction with a merchant at a point of purchase location.

2. Related Art

Advertising is used to attract the attention of customers to a brand, or a specific good or service. Advertisers may budget large sums of money for advertising campaigns that present their brands, goods, and services to existing and potential future customers of those goods and services. These campaigns may include various promotional methods and materials such as posting an advertisement, incentive programs, discounted pricing strategies, games, or combinations thereof. A goal of the advertising campaigns is to affect a lasting memory of the advertisement, and therefore, the brand, goods, or the service that is the subject of the advertising campaign.

Advertisements are commonly found in a periodical, magazine, on the internet, on television, through a direct mailing, on a billboard along a public thoroughfare, and even multimedia displays such as at a public stadium. Incentive programs, such as a customer loyalty program, may be used to reward a customer for use of a service or purchase of goods. An example of a customer loyalty program is provided by many commercial airlines in the way of a frequent flyer program. In the frequent flyer program, a customer accumulates points for miles flown with the airlines. The points are redeemable for upgrades with the carrier, customer items, or tickets for future flights. A discounted pricing strategy, or a “sale,” may draw a customer to the vendor's establishment to purchase particular items of inventory, while a rebate rewards a customer for the purchase of a specific item, or combination of items. Promotional materials may take the form of a game that may result in a reward to the customer.

Incentive programs often offer benefits that are redeemed only subsequent to a current transaction. Many incentive programs require affirmative action by the customer in order for the customer to receive the benefit. At the time of the transaction, the customer has only an expectation to receive, or a chance to receive, the benefit some time in the future. In a rebate program, in order to receive the rebate, the customer must forward a coupon and proof of purchase to the advertiser. The advertiser receives the coupon and proof of purchase and compensates the customer in the amount specified on the coupon. When the customer sends the requisite materials, the customer has only the expectation that the customer will receive the compensation in the future. The benefit is not immediately attainable, and requires action by the customer to receive the benefit.

In a customer loyalty program, the customer accumulates points. The customer may redeem the points for something of value some time in the future after a predetermined amount has been accumulated. When the customer receives the points, the customer has only an expectation that the customer may accumulate enough points to redeem for value at some time in the future. The amount of points received with any particular transaction is seldom enough to redeem for anything of substantial value. In an advertising campaign using a game, the customer has the expectation that the customer's participation will provide a chance to receive the benefit of a reward at some time in the future. Accordingly, redemption of the benefit is often disconnected from a present transaction and the instant advertising. Incentive programs provided over the Internet reward a customer only after the customer interacts with an advertiser or advertising message. These promotional programs all require interaction by the customer in order to receive an expected benefit, and are therefore limited in the affect on the attraction of the customer's attention.

In the present advertising systems, there is often a significant time lapse or delay between presenting an advertising message to the customer and providing a benefit to the customer by the advertiser. The customer is required to wait a substantial amount of time before receiving a benefit of any value. A frequent flier program, for example, often requires the customer to accumulate points over time before the points may be redeemed for value. Accordingly, multiple transactions may be required to receive a benefit that can be claimed. Coupons may be redeemable for a small benefit at the time of the transaction, and rarely result in a substantial benefit. Advertising that uses a game requires the customer to participate in the game and do not provide an assurance that the customer will receive a benefit of having substantial benefit. Because of the delayed benefit and the requisite participation, these promotional programs have a minimized affect on the ability to affect the attention or memory of the customer to the brand, service, or good. In addition, the advertiser's ability to target particular customers is limited because the customer controls its own participation in the advertising campaign.

Accordingly, there is a need for an advertising system that attracts the attention of a customer and provides an immediate substantial benefit to a customer with no or minimal interaction of the customer to receive the benefit

### SUMMARY

This invention provides a system and process for providing an advertising message. The invention is directed towards presenting an advertising message in a manner to create a surprise effect on a current or potential future customer of the advertiser. The surprise effect of the advertising message creates a conscious and subconscious appreciation for the advertiser on the customer.

The advertising message may be presented with an unexpected remuneration to a customer of a merchant, at the time the customer is participating in or proposing a transaction with the merchant. Presenting the customer with an unexpected remuneration with the advertising message surprises the customer. The advertising message, thereby, has an increased influence on the memory of customer.

The merchant may be a vendor, dealer, wholesaler, or retailer of a good, service, or combination of goods and services. The remuneration may be presented to the customer while the customer is conducting or attempting to conduct the transaction with the merchant. The remuneration may be provided to the customer at a point of purchase location of the merchant and also may result in a reduction in an amount for the instant transaction or the proposed instant transaction. The customer may therefore receive a substantially immediate and unexpected benefit.

The remuneration may be provided or sponsored by an advertiser of a brand or a customer item. The customer item may be a good, a service, or combination of goods and services. The customer item may include a good or service offered for sale by the merchant, a good or service affiliated with the goods or services of the merchant, or an unrelated good or service of the merchant.

The advertising message may include a notification to the customer that the remuneration is provided complements of advertiser. The advertising message also may include information related to the advertiser, a brand of the advertiser, and/or customer items of the advertiser. The advertiser may compensate the merchant for the amount of the price reduction, or a portion of the price reduction. The compensation may be in the form of a cash payment, a bank note, an electronic transfer, or the like.

Predetermined criteria may be evaluated prior to providing the remuneration to the customer. The criteria may be a particular time of day, day of the week or month, a threshold amount of the present transaction, a transaction for a particular good or service, any combination thereof, or the like. When it is determined that the predefined criteria are met, the customer may be presented with the advertising message and that the customer is the beneficiary of the remuneration in the form of a price reduction. The customer also may be notified that the price reduction is provided courtesy of the advertiser.

An automated accounting system may be provided at the point of purchase location for the merchant. The automated accounting system may be used to account for the transactions between the merchant and its customers. The accounting system may include a processor, computerized network, database, register, a retail terminal, or the like. The automated accounting system may be programmed to evaluate the predefined criteria, account for the price reduction, and generate the advertising message. The automated accounting system may display the message to the customer on a visual display. The automated accounting system also may generate the advertising message in a written tangible form on a printable media. The automated accounting system also may audibly present the advertising message to customer. The advertising message also may be provided to the customer by a clerk of the merchant.

Other systems, methods, features and advantages of the invention will be, or will become apparent to one of ordinary skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of an environment for presenting an advertising message at point of purchase location.

FIG. 2 is a display having an advertising message presented at a point of purchase location.

FIG. 3 is a consumer transaction receipt having an advertising message.

FIG. 4 illustrates presenting an advertising message at a point of purchase location via the Internet.

### DETAILED DESCRIPTION OF THE PREFERRED EMBODIMENTS

To give a fuller understanding of the full scope of the invention, this section describes embodiments and methodology for an advertising message at a point of purchase location. This section describes examples of the preferred embodiments of the invention and exemplary physical hardware and structures to implement and embody preferred aspects of the invention.

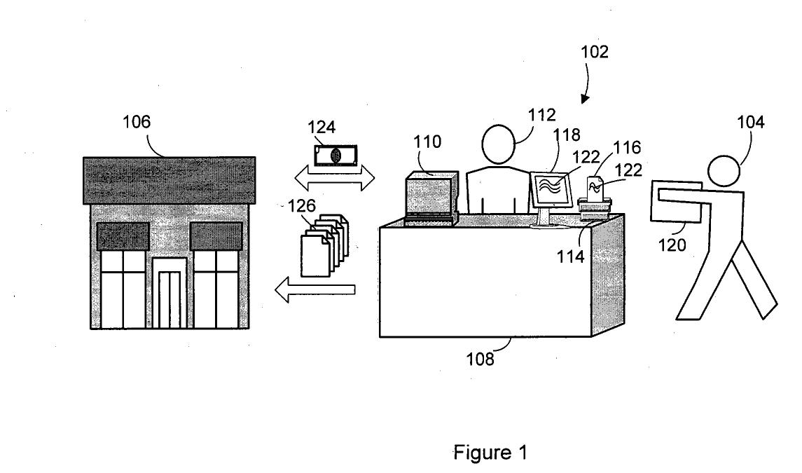

FIG. 1 illustrates an example of an environment for an advertising system for presenting a message at a point of purchase location. A merchant 102 may offer for sale a customer item 120 such as a customer good, a service, or a combination of customer goods and services. The merchant 102 may be a retailer, vendor, purveyor, agent, dealer, broker of the customer items 120, or the like. Examples for the merchant 102 include a restaurant, a gas station, a market, a grocer, an apparel retailer, a vehicle dealership, a realtor, an entertainment provider, a recreational service provider, a financial or insurance broker, or the like. Examples for the merchant 102 also include a public service provider such as a park district or zoo, or a public utility provider.

A point of purchase location 108 is provided where a customer 104 may conduct a consumer transaction with the merchant 102 for one or more customer items 120. The point of purchase location 108 may be a check-out counter, a table at a restaurant, a ticket booth, a kiosk, a service counter, a reception desk, a market stand, or the like. The point of purchase location 108 also may be a processor communicatively connected with a processor, server, Internet content provider, Internet service provider for the merchant 102 via the Internet.

The point of purchase location 108 may include an automated accounting system or retail terminal 110 configured to process data associated with the consumer transaction. The retail terminal 110 may be a cash register, an electronic data processor, a server, a computerized network, or the like. The data processed by the retail terminal 110 includes information associated with the customer 104 such as an address, a telephone number, an e-mail address, a credit history, a purchase history, or the like.

The retail terminal 110 may be coupled with a printer 114, and a visual display unit, or monitor 118. The retail terminal 110 also may be coupled with an auditory device (not shown) such as an audio speaker. The printer 114 is configured to provide written documentation of the consumer transaction, or a receipt, 116 to the customer 104. The receipt 116 may be printed by the printer 116 as the consumer transaction progresses or as the consumer transaction concludes.

The monitor 118 is configured to display visual information to the customer 104. The monitor 118 may display messages to the customer prior to, during, and at the conclusion of the consumer transaction. The message may include information associated with the consumer transaction, the merchant, customer items, or the like. The auditory device may be configured to provide an audible message to the customer 104 at the point of purchase location 108. The audible message may be provided to the customer 104 prior to, during, and at the conclusion of the consumer transaction. The audible message may include information associated with the consumer transaction.

The customer 104 may request to purchase the customer item 120 by presenting or requesting one or more customer items 120 to a clerk, or attendant, 112 at the point of purchase location 108. The clerk 112 may enter information related to the customer items 120, the customer, a customer account, and a type of transaction to the retail terminal 110. The clerk 112 may enter the information with an input device such as a keyboard, a magnetic reader, an optical scanner, any combination thereof, or the like. The retail terminal 10 processes the information and determines an amount to be tendered by customer 104 to merchant 102.

The customer 104 may tender the amount to the merchant 102 in cash, by a check, by credit card, by a debit card, any combination thereof, or the like. The retail terminal 110 is configured to process the amount tendered and account for the consumer transaction. The retail terminal 110 also is configured to provide an output to the customer as a record of the consumer transaction. The output may be provided via the monitor 118 and may also be provided via a written receipt 116 from the printer 114.

The customer 120 also may attend to the consumer transaction with minimal or no intervention of the clerk 112. The retail terminal 110 may be configured to allow the customer 104 to attend to the consumer transaction. The customer enters information to be processed by the retail terminal 110 such as information related to the customer items 120, the customer 104, a customer account, and a type of transaction. The retail terminal 110 processes the information and determines an amount due by customer 104 to merchant 102. The customer 104 tenders the amount in cash, by a check, by credit card, by a debit card, any combination thereof, or the like. The retail terminal 110 is configured to process the amount tendered and account for the consumer transaction. The retail terminal 110 also may dispense any change to the customer 104. The retail terminal 110 also is configured to provide an output to the customer as a record of the consumer transaction. The output may be provided via the monitor 118 and may be provided via a written receipt 116 from the printer 114.

An advertiser 106 may attract the attention of the customer 104 of merchant 102 with an advertising message. The advertiser 106 also may be a business, association, alliance, enterprise, firm or any other organization that desires to attract the attention of the customer 104. The advertiser 106 may be a manufacturer, distributor, retailer, vendor, dealer, of goods, services, or combination of goods and services, or the like. The advertiser 106 may have a brand associated with the goods and/or services of advertiser 106. The goods and/or services of advertiser 106 may be complementary to or associated with the customer item 120 of merchant 102. The customer item 120 of merchant also may include the goods and/or services of the advertiser 106.

The advertiser 106 may establish a budget $X for an advertising campaign to present advertising messages. The advertiser 106 may expect that the budget $X will allow an advertising campaign that includes presenting the advertising message to Y audience members. The Y audience members may include a percentage “n” of potential future customers of advertiser 106. Therefore, the advertiser 106 may allocate $X/nY for each potential future customer of the advertiser 106.

With the advertising campaign, the advertiser 106 may desire to maximize an impact of the advertising message presented to the potential future customers nY. The advertiser 106 also may desire to attract the attention of the greatest number of potential future customers nY with the budget $X. Therefore, the advertiser 106 may desire to maximize the impact of the advertising message while minimizing the ratio $X/nY. As the ratio $X/nY decreases, the advertiser may have a greater return for each unit of currency of the budget $X. The advertiser 106 may minimize the ratio $X/nY by presenting the advertising message to a demographic having a larger percentage of potential customers n.

The advertiser 106 may allocate $X/nY based on an estimated or expected impact of the advertising message on the potential future customer. The advertiser 106 may allocate a larger $X/nY for an advertising message that is expected to have a larger potential in attracting the attention of potential customers of advertiser 106. In order to attract the attention of the greatest number of potential customers, the advertiser 106 also may present the advertising message to a particular demographic that includes likely or potential future customers. The demographic may be determined, for example, through a market analysis or demographic study. The advertiser 106 also may determine a related market for the brand of advertiser 106, or a potential for cross-branding the brand of advertiser 106 with goods and/or services of another such as the customer item 120 of merchant 102. The advertiser 106 may determine to present the advertising message to particular individuals, in a particular location, or in a particular media that is expected to have a high percentage n. The advertiser 106 may determine that the demographic of the customer 104 of merchant 102 includes likely or potential future customers of advertiser. Advertiser may therefore present the advertising message to the customer 104 of merchant 102.

The merchant 102 and the advertiser 106 may agree that the advertiser 106 may present the advertising message 122 to the customer 104 at the point of purchase location 108. The merchant 102 may agree to allow the advertiser 106 to present the advertising message to the customer 104 for consideration or other concession provided to the merchant 102. The advertiser 106 may compensate the merchant 102 for a prospect of presenting advertising messages at the point of purchase location 108 of merchant 102. The merchant 102 also may agree to allow the advertiser 106 to present the advertising message 122 in return for advertiser allowing the merchant 102 to present an advertising message to a customer of the advertiser 106 at a point of purchase location for the advertiser 106. The merchant 102 also may agree because the merchant 102 may experience an increase in sales due to the activities of the advertiser 106 in presenting advertising messages at the point of purchase location 108. The merchant 102 also may consent as a concession to advertiser 106.

The advertiser 106 may present the advertising message 122 at the point of purchase location 108 to attract the attention of a customer 104 at the point of purchase location 108. The advertising message 122 may be presented to the customer 104 prior to, during, or at the conclusion of a consumer transaction between the customer 104 and the merchant 102. The advertising message may be displayed on the monitor 118. The advertising message 122 also may be provided on the written receipt 116. The advertising message 122 may include information related to one or more brands, goods, services, and combination of goods and services of the advertiser 106. The advertising message 122 also may include information related to the advertiser 106 such as a location for a place of business for advertiser 106.

A remuneration may be presented to the customer 104 with the advertising message 122. The advertising message 122 also may include information that the remuneration is provided, or sponsored, by the advertiser 106. The remuneration may be a reduction in the amount, or price, of the present consumer transaction between the merchant 102 and the customer 104. The remuneration also may be a cash compensation, a credit to an account for the customer 104 with the merchant 104, a credit to an account with the advertiser 106, a debit to customer loyalty account with the merchant 104 and/or advertiser 106, or any combination thereof. The advertising message 122 presented to the customer 104 at the point of purchase location 108 with the remuneration may have a greater potential to attract the attention of the customer 104.

The remuneration may be provided to the customer 104 without requiring an affirmative act by the customer 104. The remuneration may be provided to the customer 104 prior to the customer 104 having an expectation to receive the remuneration or a chance of receiving the remuneration. The remuneration may be provided to the customer 104 prior to the customer 104 entering or having an agreement with the advertiser 106 whereby the customer 104 has the expectation to receive the remuneration or the chance to receive the remuneration. The remuneration may be available for use with the present consumer transaction such as a price reduction, without an affirmative act or response of the customer 104. The remuneration also may be provided to the customer 104 for a future transaction with the merchant 102 or the advertiser 106. The customer 104 may therefore receive an unexpected price reduction or other form of compensation and the advertising message 122 may have a greater impact on the customer 104. Presenting the customer 104 with an unexpected remuneration and the advertising message 122 creates a positive conscious and subconscious appreciation for the advertiser on the customer. Because an affirmative act of the customer to receive the benefit is not required, the unexpected remuneration may create an increased impact or influence on the customer 122. In addition, the unexpected remuneration may also create an increased impact on the customer 122 due to a value of the remuneration to the customer 106. The remuneration may create a longer a lasting-effect on the memory of customer. The advertising system provides an increased ability to influence current or potential future customers of the advertiser 106.

The retail terminal 110 may be configured to process, or account, for each remuneration provided to the customer 104. The retail terminal 110 may be configured to determine an amount for the remuneration. The amount of the remuneration may be based on a percentage of the amount for the present transaction between the merchant 102 and the customer 104. The amount of the remuneration also may be a predetermined amount of the amount of the present transaction between the merchant 102 and the customer 104. The retail terminal 110 may be configured to determine an overall number of advertising messages associated that may be presented at the point of purchase location 108. The overall number may be based on a total budget allocated by the advertiser 106 to the merchant 102. For each remuneration presented at the point of purchase location 108, the retail terminal 110 may add the amount of the remuneration to the total. When the total reaches a threshold, the advertising message may be provided without a remuneration. When the total reaches the threshold, a summary 126 may be generated, which may include data associated with the total remuneration presented, the form of each remuneration, the amount for each remuneration, the customer, or the like. The summary 126 may be provided to the merchant 102 and may also be communicated with the advertiser 106. The summary 126 may be communicated to the advertiser 106 via postal mail, via an e-mail, or a modem connection to a processor of the advertiser 106, via facsimile, any combination thereof, or the like. The advertiser 106 may reimburse the merchant 102 in an amount based on the total remuneration or a percentage of the total remuneration presented.

The remuneration may be an amount having significant value for the customer 104. As described above, the advertiser 106 may budget $X/nY, for each potential customer of advertiser 106. The effect of the unexpected benefit of the remuneration to a specific customer 104 allows the advertiser to select a ratio $X/nY that may provide an immediate benefit of value to the customer 104. The advertising message 122 presented with the remuneration may have a greater potential for attracting the attention of the customer 104. In addition, the advertising message may be presented to the demographic Y having an increased percentage n of potential future customers. The advertiser 106, therefore, may budget a ratio $X/nY that may be greater than an advertising message having a lower percentage n of potential customers. The remuneration may be equal to or a large percentage of $X/nY.

By way of example, advertiser 106 may have a budget of $100,000 for presenting advertising messages to potential future customers. Traditional advertising campaigns include allocating the budget to a mass media where there is a very high audience Y but a possibly very low percentage of potential customers. The advertiser 106 may expect with such a campaign that the $100,000 may yield, for example 10,000 future customers out of a total audience Y of 1,000,000. Therefore, the advertiser 106 may allocate $10.00 per future customer. In accordance with the present invention, the advertiser 106 may present the advertising message 122 to a specific demographic including the customers of merchant 102. The advertiser 106 may provide the advertising message 122 to the customer 104 with a remuneration having a value of $10.00 and may present the advertising message 122 to 10,000 customers having a greater potential for becoming a future customer of advertiser 106. The advertising system may target providing quality advertising, as opposed to a high quantity of advertisements.

The remuneration may be presented to the customer 104 according to predefined criteria. The criteria may include a time of day, day of week, the amount of present transaction, a particular customer item 120 or combination of customer items 120 included in the present transaction, a location for the merchant 102, or the like. The retail terminal 110 may be configured to evaluate the criteria and determine whether to present the remuneration to the customer 104. The advertiser 106 and/or the merchant 102 also may evaluate the criteria to determine whether to present the remuneration to the customer 104. The remuneration, therefore, may be presented according to the time of day, day of the week or month, to each customer at a particular location for the merchant 102, to each customer that purchases a selected customer item or combination of customer items, or any combination thereof.

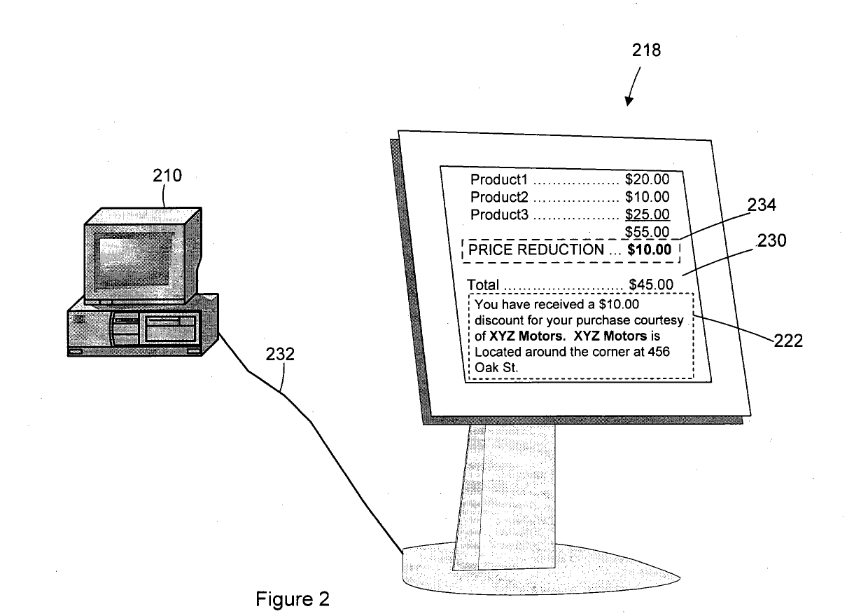

FIG. 2 illustrates an example of a video display unit, or monitor, 218 configured to present an advertising message 222. The monitor 218 may be coupled to a retail terminal 210 through a coupling mechanism 232. The coupling mechanism 232 includes a universal serial bus (“USB”), a serial interface, an analog audio connection, or a radio wave wireless connection, an infra-red connection, a wireless connection according to Bluetooth communication standards, and the like. The monitor 218 receives a display signal from the retail terminal 210, through the connection mechanism 232.

The monitor 218 is configured to display a visual image in response to the signal received from the retail terminal 210. The monitor 218 may be configured to display a visual image such as a still image, computer generated image, video image, a combination of any of still, computer-generated or video images, or the like. The monitor 218 may be positioned to display the visual image to the customer 104 at the point of purchase location 108 of the merchant 102. The monitor 218 also may be configured to display the advertising message prior to a consumer transaction.

In response to the signal received from the retail terminal 210, the monitor 218 may display a record of a consumer transaction, or receipt, 230. The receipt 230 may be displayed while the consumer transaction is being processed. The receipt 230 also may be displayed as the consumer transaction concludes. The monitor 218 also may display an advertising message 222. The advertising message 222 may be displayed prior to, in conjunction with, or subsequent to displaying the receipt 230. The advertising message 222 may include information associated with the advertiser 106. The advertising message 222 also may include information related to the remuneration 234 presented to the customer 104 and that the remuneration 234 is provided by or sponsored by the advertiser 106. The receipt 230 may account for the remuneration 234 presented to the customer 104.

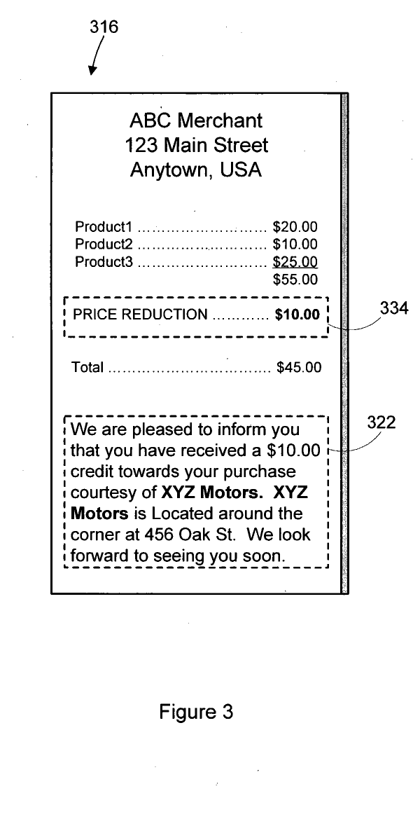

FIG. 3 illustrates an example of a written record of the consumer transaction, or receipt 316. The receipt 316 may include a record of the consumer transaction for the customer 104. The receipt 316 also may be a ticket or pass, such as an entrance ticket to a theater, or sporting event, or a pass for commercial transportation, or the like. The printer 114 may generate the receipt 316 in response to a signal received from the retail terminal 110. The receipt 316 may be generated as a result of the consumer transaction between the merchant 102 and the customer 102. The receipt 316 may be generated during the transaction or as the consumer transaction concludes.

The receipt 316 may include an advertising message 322. The advertising message 322 may include information associated with the advertiser 106. The advertising message 322 also may include information related to remuneration 334 presented to the customer 104 and that the remuneration 334 is provided by or sponsored by the advertiser 106. The receipt 316 may account for the remuneration 334 presented to the customer 104.

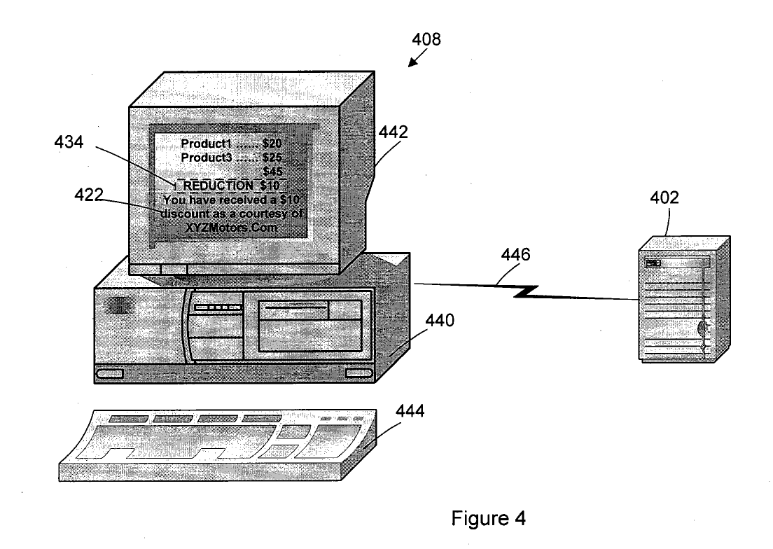

FIG. 4 illustrates an advertising message 422 that is presented via an Internet connection. A merchant may offer for sale a good, service or a combination of a good and service via Internet content that is accessible through the Internet. The Internet content may be provided or stored on an Internet server 402, a combination of servers 402, or a computerized network accessible through the Internet. A customer may access the server with a computer terminal 408. The computer terminal 408 may be a computerized network, a personal computer, a laptop computer, a tablet PC, a personal digital assistant, a personal digital computer, a portable telephone, a kiosk, or the like. The computer terminal 408 may include a video terminal, or monitor 442, and input device 444 such as a keyboard or touchpad, and a processor 440. The processor 440 is configured to process input from the input device 444 and display visual images on the monitor 442. The processor may also have a communications device such as a modem, a DSL connection, or a cable connection. The communications device also may be a wireless connection. The communications device may be configured to transmit and receive data via a telephone connection, an open network connection, a direct connection to a computer network, or the like.

The computer terminal 408 may be configured to receive responses from a customer. The computer terminal may transmit the responses via the Internet connection 446. The computer terminal 408 also may be configured to receive Internet content from the server 402 via the Internet.

The customer may access a website associated with the merchant with the computer terminal 408. The computer terminal 408 may display the Internet content of the merchant, which may include offers for sale of a customer item. The customer may request to purchase the customer item or initiate a consumer transaction with the merchant through an input to the computer terminal 408. The customer may provide information associated with the consumer transaction via the computer terminal 408. The computer terminal 408 receives the information from the customer and communicates the information with the server 402 via the Internet connection 446. The server 402 may receive the request from the computer terminal 408. The server 402 processes the transaction and communicates the results of the processing to the computer terminal 408. The computer terminal 408 may display the results on the monitor 442.

The server 402 also may be configured to determine whether to communicate an advertising message 422 to the customer. The server 402 may communicate the advertising message according to predetermined criteria. The computer terminal 408 may receive the advertising message 422 from the server 402 and display the advertising message 422 on the monitor. The advertising message 422 may be a banner advertisement, a pop-up advertisement, a pop-behind advertisement, or the like. The advertising message 422 also may be communicated with the results of the processing of the consumer transaction.

The server 402 also may be configured to determine whether to communicate an advertising message 422 to the customer. The server 402 may communicate the advertising message 422 according to predetermined criteria. The advertising message 422 also may be communicated to the computer terminal 408 with the results of the processing of the consumer transaction. The computer terminal 408 may receive the advertising message 422 from the server 402 and display the advertising message 422 on the monitor. The advertising message 422 may be a banner advertisement, a pop-up advertisement, a pop-behind advertisement, or the like. The advertising message 422 also may be displayed with the results of the processing of the consumer transaction.

The server 402 also may be configured to determine whether to present a remuneration 434 to the customer with the advertising message 422. The server 402 may present the remuneration 434 according to predetermined criteria. The remuneration 434 may be presented to the customer with the advertising message 422. The remuneration 434 may be displayed on the computer terminal 442 with the results of the processing of the consumer transaction.

Various embodiments of an advertising message presented with a remuneration at a point of purchase location have been described and illustrated. The description and illustrations, however, are by way of example only. Many more embodiments and implementations are possible within the scope of this invention and will be apparent to those of ordinary skill in the art. The various embodiments can be applied to a wide variety of environments, such as retail outlets, theaters, restaurants, sporting events, zoos, or any combination thereof. Accordingly, similar scenarios may be described in situations where an advertising message is presented to a customer by manufacturer or distributor of a soft drink at a gas station outlet, by a car dealership at a movie theater, by a restaurant at a soccer game, or by a financial firm at a grocery market.

This invention provides a heightened impact on the customer and allows the advertiser to target a particular demographic and attract the attention of potential customers with an incentive having substantial value to the customer. The invention also provides benefits to the merchant due to possible increased traffic and sales do to the system being implemented at the merchant's place of business or point of purchase location. The customer receives a benefit in the form of the unexpected remuneration received at the point of purchase location.

An embodiment of the invention may include a point of purchase location of a merchant having a clerk, or other attendant, that attends to a consumer transaction with a customer of the merchant's goods, services, or combination of goods and services. The customer may order, request, or otherwise purchase the merchant's goods and/or services at the point of purchase location. Predefined criteria may be evaluated to determine whether the customer is eligible to receive a price reduction for the goods or services ordered. The price reduction is subsidized in whole, or in part, by an advertiser. The advertiser may be a manufacturer, distributor, merchant, vendor, retailer, dealer, agent or the like of good, services, or combination of goods and services. The predefined criteria may be a particular time of day, day of the week, an order for particular or combination of goods or services, a total purchase price of goods or services ordered, the merchant's location, or any other criteria that the advertiser may use to select a customer that is to receive the advertising message and price reduction.

When the predefined criteria are met, the customer is presented with a message that the customer has received a price reduction and that the price reduction is provided courtesy of the advertiser. The price reduction may be a certain percentage of the retail price, or a specified amount of the purchase price of the consumer transaction with the merchant. The message may also include information about the advertiser, its brands, it products, or its services. The customer tenders to the merchant an amount reflecting the reduced price. The advertiser may reimburse the merchant for the amount of the price reduction, or portion thereof. It is intended that the message may be included as part of a receipt, invoice, ticket, or other document that the customer ordinarily receives from the merchant as the result of the consumer transaction. Alternatively, the sales clerk or vendor's automated register may audibly provide the advertising message to a customer.

In one example, the point of purchase location may be a counter in a fast food restaurant. The advertiser may be an automobile manufacturer. The automobile manufacturer may desire to attract the attention of the customers at the fast food restaurant. The automobile manufacturer may establish predefined criteria to attract a particular demographic of the customers of the fast food restaurant. Accordingly, the predefined criteria, such as time of day or food items ordered, may be evaluated to determine whether a customer is eligible to receive a price reduction.

When it is determined that predefined criteria are met, the customer receives a price reduction for the food items ordered. The customer also is presented with a message that includes information associated with the automobile manufacturer and includes notification of the price reduction. The message may include information that the amount that the customer is to tend to the clerk has been reduced courtesy of the automobile manufacturer. The message may also include information about the automobile manufacture, its brands, or any other message that the automobile manufacturer may desire to present to the customer. The fast food restaurant may be reimbursed in the amount of the price reduction, or portion thereof, by the automobile manufacturer.

The point of purchase location also may include an electronic communication such as a wireless telephone. The telephone may be a cellular telephone, a personal digital assistant, a personal computer, or the like. The telephone may include a display configured to provide text messages to the customer. The advertiser may be any advertiser of a customer item such as a restaurant. The restaurant may desire to present an advertising message to customers, or certain customers of a hotel. The restaurant may establish predefined criteria to attract a particular demographic of the customers of the hotel. The customer may be conducting a transaction with the hotel or reserving a room with the hotel via the telephone communication. When it is determined that predefined criteria are met, the customer may receive notification via the telephone display that the customer has received a price reduction for the services requested. The message may include information associated with the restaurant and may also include information related to a location for the restaurant. The message may include information that the amount that the customer is to tend to the hotel has been reduced courtesy of the restaurant. The hotel may be reimbursed in the amount of the price reduction, or portion thereof, by the restaurant.

Various other embodiments may be employed where the price reduction and advertising message may be provided by any advertiser at point of sales location such as a record store, a movie cinema, a sports stadium, a computer via the internet, a mobile phone, a telemarketing program, home-delivery service, or vendors of financial instruments. The message may be presented as part of a receipt for the transaction, an entrance ticket, a billboard message, an oral message from the clerk, sales representative, or other attendant, or a computer, or video or electronic multimedia display.

The invention provides benefits to the customer in the form of a reduced price, to the merchant in the form of increased customer traffic, and to the advertiser in the form of an advertisement having an increased impact on a targeted demographic. The advertiser may attract the attention of the customer to his brand, products, and services by presenting the advertising message with an unexpected price discount at a point of purchase location for certain goods and services.

It is intended in the appended claims to cover all such changes and modifications which fall within the true spirit and scope of the invention. Therefore, the invention is not limited to the specific details, representative embodiments, and illustrated examples in this description. Accordingly, the invention is not to be restricted except in light as necessitated by the accompanying claims and their equivalents.

1. An advertising system, comprising:
a remuneration sponsored by an advertiser, the remuneration being presented to a customer conducting a consumer transaction with a merchant at a point of purchase location and being associated with a price reduction for the consumer transaction, the remuneration being presented in response to the customer initiating the transaction; and
an advertising message associated with the advertiser and being presented to the customer with the remuneration.

2. The advertising system of claim 1 where the advertising message includes notification to the customer of the remuneration and notification that the remuneration is sponsored by the advertiser.

3. The advertising system of claim 2, where the remuneration is presented to the customer according to predetermined criteria.

4. The advertising system of claim 3 further comprising an automated retail terminal configured to process the consumer transaction and to evaluate the predetermined criteria, the automated retail terminal being located at the point of purchase location.

5. The advertising system of claim 4 where the automated retail terminal includes an output device, the output device configured to present the advertising message to the customer.

6. The advertising system of claim 5 where the output device comprises a visual display unit, the advertising message being displayed on the visual display unit.

7. The advertising system of claim 5 where the output device comprises a printer configured to generate a receipt for the transaction, the advertising message being associated with the receipt.

8. The advertising message of claim 5 where the output device comprises an auditory device configured to present the advertising message to the customer.

9. The advertising system of claim 5 where the remuneration is a predetermined amount.

10. The advertising system of claim 5 where the advertiser compensates the merchant for a percentage of the price reduction.

11. The advertising system of claim 5 where the predetermined criteria are selected from the group consisting of a time of the transaction, a date of the transaction, an amount for the transaction, a particular good purchased, a particular service purchased, a combination of goods purchased, a combination of services purchased, a number of transactions, a location of the merchant, and a location of the point of purchase location.

12. The advertising system of claim 5 wherein the merchant comprises a service provider.

13. The advertising system of claim 5 where the transaction is conducted via the Internet and the advertising message is provided to the customer via a computer terminal connected to a web site associated with the merchant via the Internet.

14. A method for presenting an advertising message, comprising:
(a) offering for sale a customer item associated with a vendor;
(b) processing with a retail terminal, a consumer transaction with a customer at a point of purchase location, the transaction being for the customer item and characterized by a purchase price;
(c) in response to (b), presenting the customer with a reduction in the purchase price, the reduction being sponsored by an advertiser, and being presented in conjunction with an advertisement of the advertiser, the advertiser being associated with a customer item other than the customer item offered for sale by the vendor; and
(d) processing with the retail terminal, the reduction in the purchase price.

15. The method of claim 14 further comprising presenting the customer with the reduction in the purchase price according to predetermined criteria.

16. The method of claim 15 where the customer item associated with the vendor comprises a service provided by the vendor.

17. An retailer terminal, comprising:
means for processing a consumer transaction between a customer and a vendor, the means for processing being located at a point of purchase location for the vendor;
a means for evaluating predetermined criteria, the means for evaluating being operative in response to the means for processing;
a means for presenting the customer with a remuneration and an advertising message, the remuneration being associated with a price reduction for the consumer transaction with the vendor, and the advertising message being associated with an advertiser, and the advertiser sponsoring the remuneration, the means for notifying being operative in response to the means for evaluating; and
a means for processing the price reduction.

18. The system of claim 17 where the vendor is a merchant of goods.

19. The system of claim 18 where the vendor is a service provider.

20. The system of claim 19 where the means for processing comprises the means for evaluating, the means for presenting and the means for processing.
